(19) United States
(12) Patent Application Publication
(10) Pub. No.: US 2021/0048258 A1
(43) Pub. Date: Feb. 18, 2021

(54) HEAT EXCHANGE DEVICE

(71) Applicant: HINEND CO., LTD., Seoul (KR)

(72) Inventors: Seung-Sik HWANG, Seoul (KR); Gyuhong CHOI, Seoul (KR); Hyunjong JUNG, Goyang-si (KR)

(73) Assignee: HINEND CO., LTD., Seoul (KR)

(21) Appl. No.: 16/966,887

(22) PCT Filed: Feb. 28, 2018
(86) PCT No.: PCT/KR2018/002424

§ 371 Date: Aug. 1, 2020

(30) Foreign Application Priority Data
Feb. 1, 2018 (KR) 10-2018-0012831

(51) Int. Cl. F28F 9/02; F28D 7/16

(52) U.S. Cl. CPC F28F 9/0278; F28D 21/0014; F28D 7/1607

(57) ABSTRACT

A heat exchange device effectively collects heat in a device, in which high temperature occurs, such as a scrubber. The heat exchange device includes a first heat exchange unit having a reactor positioned on the center thereof and having a first passage, which is arranged to enclose the reactor and discharges a first gas generated in the reactor, and a second passage, which is arranged adjacent to the first passage and introduces a second gas introduced from the outside. A second heat exchange unit is installed to enclose the first heat exchange unit and having a third passage, which is connected to the first passage and receives the first gas from the first passage to discharge the first gas to the outside, and a fourth passage, which is arranged adjacent to the third passage and introduces the second gas introduced from the outside into the second passage.

### TECHNICAL FIELD

The present disclosure relates to a heat exchange device, and more particularly, to a heat exchange device for effectively recovering heat from a device generating high-temperature heat, such as a scrubber.

### BACKGROUND ART

In general, semiconductors, LEDs, LCDs, and solar cells are manufactured at high temperatures using a gas such as hydrogen (H₂), silane (SiH₄)-based gas such as monosilane and disilane, and ammonia (NH3). In the combustion process of hydrogen, the silane-based gas, ammonia, and the like, flammable gas and waste gases such as toxic gas contained therein are discharged into the atmosphere without filtration, which has a significant adverse effect on the human body and causes air pollution.

Accordingly, various types of treatment methods have been provided to treat waste gases such as flammable gases and toxic gases emitted during semiconductor manufacturing. A representative example is using a wet-type or dry-type scrubber, and when necessary, a separate filter or an adsorption layer may be arranged before and after the scrubber to increase treatment efficiency.

The wet-type scrubber is a structure that scrubs and cools toxic gases using water and has a relatively simple configuration, and is thus easy to manufacture and also can have a large capacity. The dry-type scrubber is a structure in which a toxic gas is caused to pass through a burner such as an air burner or an oxygen burner so as to be directly burned, or a structure in which a high-temperature chamber is formed using a heat source and a toxic gas is indirectly burned while passing through the chamber at a high speed. The dry-type scrubber has an excellent effect in the treatment of flammable gas.

These scrubbers are generally operated to rapidly cool hot gases to a temperature at which post-processing is possible. Accordingly, the scrubber facility is generally designed and operated to radiate heat to the surroundings without considering insulation.

Here, if the energy of a high-temperature fluid generated from the scrubber and the heat energy dissipated from the facility are recovered, the energy consumed by the scrubber may be significantly reduced.

A heat exchange device, which is a facility capable of controlling temperature and recovering energy through heat exchange between a high-temperature fluid and a low-temperature fluid, is widely used throughout the industry.

In a process having a wide temperature range, it is common to operate multiple heat exchange devices disposed in series according to suitable temperature ranges, rather than operating a single heat exchange device. However, the heat exchange devices connected in series raise an issue regarding the space they occupy and require a separate duct space for fluid connection between the devices.

### DISCLOSURE

### Technical Problem

Therefore, it is one object of the present disclosure to provide a heat exchange device for effectively recovering heat while minimizing the space occupied by the heat exchange device in a device generating high temperatures, such as a scrubber.

### Technical Solution

In accordance with one aspect of the present disclosure, provided is a heat exchange device including a first heat exchanger having a reactor formed in a center thereof, the first heat exchanger including a first passage disposed to surround the reactor and allowing a first gas generated in the reactor to be discharged thereinto; and a second passage disposed adjacent to the first passage to receive a second gas introduced from an outside; and a second heat exchanger arranged to surround the first heat exchanger, the second heat exchanger including a third passage connected to the first passage to receive the first gas from the first passage and discharge the first gas to the outside; and a fourth passage disposed adjacent to the third passage and configured to introduce the second gas introduced from the outside into the second passage.

In heat exchange device, the second heat exchanger may be arranged to surround a lateral surface of the first heat exchanger.

In the heat exchange device, the first to fourth passages may be formed perpendicular to a ground.

In the heat exchange device, at least one of the first passage and the second passage may be formed of a tube, and the other is formed in a shell shape to accommodate the tube. The heat exchange device may further include a cover arranged on a top of the first heat exchanger and the second heat exchanger to discharge the first gas discharged from the third passage to the outside and to receive the second gas from the outside and introduce the second gas into the fourth passage; and a flow path changer disposed at a bottom of the first heat exchanger and the second heat exchanger to face the cover to form communication flow paths between the first passage and the third passage and between the second passage and the fourth passage.

In the heat exchange device, the cover may include a first cover communicating with the first passage to transfer the first gas from the reactor to the first passage; a second cover disposed spaced apart from the first cover and having a first duct communicating with the third passage to discharge the first gas discharged from the third passage to the outside; and a third cover disposed spaced apart from the second cover and having a second duct communicating with the fourth passage to introduce the second gas introduced from the outside into the fourth passage.

In the heat exchange device, the flow path changer may include a source accommodation portion forming a space in a center thereof to communicate with the reactor, the source accommodation being provided with a source for reaction in the reactor; a first flow path changer configured to introduce, into the second passage, the second gas introduced through the fourth passage; a second flow path changer configured to introduce, into the source accommodation portion, the second gas introduced through the second passage by the first flow path changer; and a third flow path changer configured to discharge the first gas discharged from the first passage through the reactor into the third passage.

In the heat exchange device, the cover and the flow path changer may be detachably coupled to the first and second heat exchangers.

In the heat exchange device, the first gas and the second gas may form counter-flows by moving in opposite directions.

### Advantageous Effects

A heat exchange device according to the present disclosure allows primary heat exchange to be performed between a first gas generated in a reactor and a second gas introduced from the outside through a first heat exchanger, and allows secondary heat exchange to be performed between the first gas and the second gas having undergone the primary heat exchange through a second heat exchanger surrounding the outer part of the first heat exchanger. Accordingly, the space occupied by the heat exchange device may be minimized and the heat of the first gas generated from the reactor may be effectively recovered.

In the heat exchange device according to the present disclosure, heat exchange is performed in each of the first heat exchanger and the second heat exchanger, and the second heat exchanger surrounds the first heat exchanger. Accordingly, additional heat exchange is caused between the first heat exchanger and the second heat exchanger, and thus heat exchange efficiency may be maximized.

In addition, since the second heat exchanger, which is at a lower temperature than the first heat exchanger, surrounds the first heat exchanger, the heat exchange device according to the present disclosure may minimize heat loss without using a separate insulator.

In addition, as the passages of the first heat exchanger and the second heat exchanger are arranged in a direction perpendicular to the ground (gravity direction), the heat exchange device according to the present disclosure may prevent dust contained in the first or second gas from accumulating in the passages.

In addition, as a cover and a flow path changer that form flow paths of the first heat exchanger and the second heat exchanger are detachably coupled to the top and bottom of the first and second heat exchangers, respectively, maintenance of the heat exchange device according to the present disclosure may be facilitated.

Further, in the heat exchange device according to the present disclosure, the first heat exchange device performs heat exchange in a temperature range within which high-temperature corrosion may occur, and the second heat exchange device performs heat exchange in a temperature range lowered through heat exchange. Since the second heat exchange device surrounds the first heat exchange device, expensive materials with strong resistance employed for a first heat exchanger may be minimized, and thus costs may be reduced. In addition, by causing a second heat exchanger to perform heat exchange in a range where there is no risk of high-temperature corrosion, the intended heat exchange efficiency may be reached.

In other words, by selectively applying materials of the first heat exchanger and the second heat exchanger, the heat exchange device according to the present disclosure may be configured to have a compact size and the overall heat exchange efficiency and durability thereof may be improved.

### DESCRIPTION OF DRAWINGS

FIG. 1 is an assembly perspective view showing a heat exchange device according to an embodiment of the present disclosure.

FIG. 2 is an exploded perspective view showing the heat exchange device according to the embodiment of the present disclosure.

FIG. 3 is a perspective view showing a first heat exchanger according to an embodiment of the present disclosure.

FIG. 4 is a perspective view showing a second heat exchanger according to an embodiment of the present disclosure.

FIG. 5 is a cross-sectional side view of the second heat exchanger according to the embodiment of the present disclosure.

FIG. 6 is a perspective view showing a flow path changer according to an embodiment of the present disclosure.

FIG. 7 is a view illustrating the flow of first and second gases in the heat exchange device according to the embodiment of the present disclosure.

### BEST MODE

It should be noted that only parts necessary for understanding the embodiments of the present disclosure are described below, and descriptions of other parts will be omitted to avoid obscuring the subject matter of the present disclosure.

The terms or words used in the present disclosure and claims described below should not be interpreted as being limited to ordinary or lexical meanings, and should be interpreted as meanings and concepts consistent with the technical spirit of the present invention, based on the principle that the inventor can properly define the terms to best explain the invention. Accordingly, the embodiments disclosed in this specification and the configurations shown in the drawings are merely preferred embodiments of the present disclosure, and do not represent all the technical spirit of the present disclosure. Therefore, it should be understood that there may be various equivalents and variations that can replace the embodiments and the configurations at the time of filing this application.

Hereinafter, embodiments of the present disclosure will be described in detail with reference to the accompanying drawings.

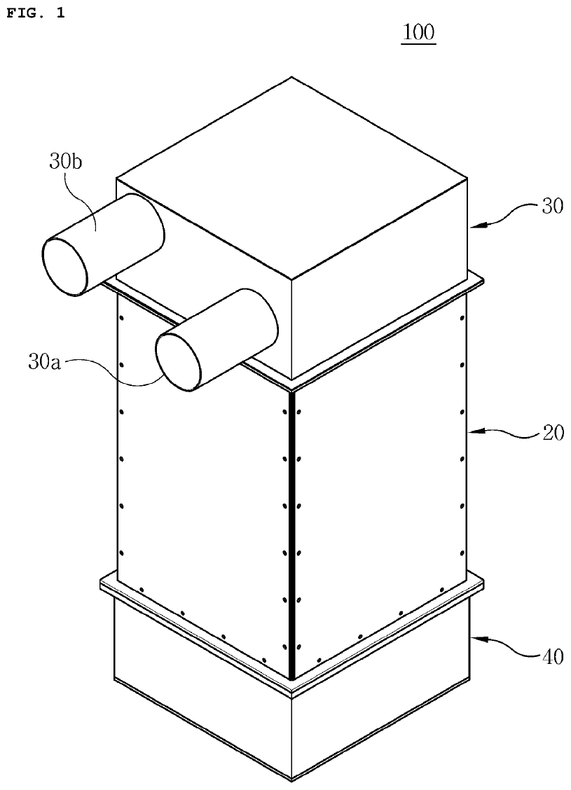

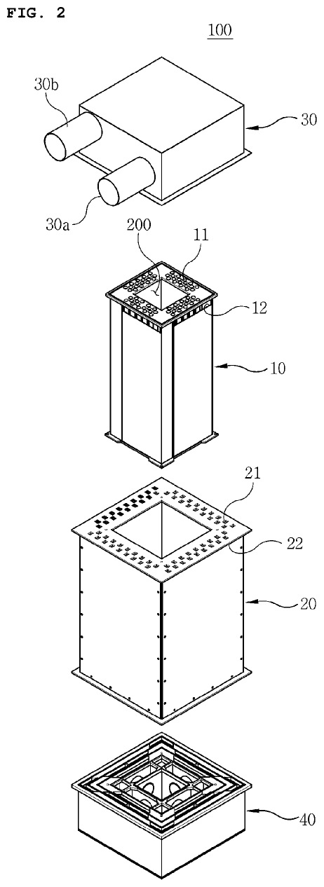

FIG. 1 is an assembly perspective view showing a heat exchange device according to an embodiment of the present disclosure, and FIG. 2 is an exploded perspective view showing the heat exchange device according to the embodiment of the present disclosure.

Referring to FIGS. 1 and 2, a heat exchange device 100 according to an embodiment of the present disclosure includes a first heat exchanger 10 and a second heat exchanger 20.

The first heat exchanger 10 may cool a first gas generated from a reactor 200 through heat exchange with a second gas flowing from the outside, and discharge the same to the second heat exchanger 20.

In addition, the first heat exchanger 10 may receive the second gas from the second heat exchanger 20 and introduce the second gas into the reactor 200.

Here, the first gas may be a high-temperature gas processed as the second gas introduced from the outside passes through the reactor 200. The temperature of the second gas may be lower than that of the first gas introduced from the outside. The second gas may be waste gas including a flammable gas and a toxic gas to be processed in the reactor 200.

The reactor 200 may be formed in a hollow shape with an open top and bottom, and the horizontal cross section thereof corresponding to the outer lateral surfaces of the first heat exchanger 10 may be formed in a hollow shape such as a circle, a rectangle, or a hexagon. A scrubber may be installed inside the reactor 200 to process the second gas introduced from the outside and discharge the same to the outside. For example, the scrubber installed in the reactor 200 may use a method of chemically treating waste gas introduced from the outside using a catalyst, or various other methods such as treating waste gas through combustion using a burner. Here, the scrubber is applicable to any facility that handles toxic gases containing reactive byproducts.

The second heat exchanger 20 may be installed on the outer surface of the first heat exchanger 10 so as to surround the first heat exchanger 10. The second heat exchanger 20 may be arranged to communicate with the first heat exchanger 10 to receive the first gas that is discharged from the reactor 200 and cooled through the first heat exchanger 10 for the first time. Then, it may cool the first gas for the second time through heat exchange with the second gas introduced from the outside.

Here, the second heat exchanger 20 may be disposed to directly contact the first heat exchanger 10, and thus may perform internal heat exchange and additional heat exchange with the first heat exchanger 10, thereby increasing the heat exchange efficiency.

That is, the heat exchange device 100 according to the embodiment of the present disclosure may cause first heat exchange between the first gas generated in the reactor 200 through the first heat exchanger 10 and the second gas introduced from the outside, and cause second heat exchange between the first gas having undergone the first heat exchange and the second gas through the second heat exchanger 20, which surrounds the outer side of the first heat exchanger 10. Thereby, the space occupied by the heat exchange device 100 may be minimized and the heat of the first gas generated from the reactor may be effectively recovered.

Since heat exchange occurs in each of the first heat exchanger 10 and the second heat exchanger 20, and the second heat exchanger 20 is arranged to surround the first heat exchanger 10, the heat exchange device 100 according to the embodiment of the present disclosure may cause additional heat exchange between the first heat exchanger 10 and the second heat exchanger 20, thereby maximizing heat exchange efficiency.

In addition, since the second heat exchanger 20 at a lower temperature than the first heat exchanger 10 surrounds the first heat exchanger 10, the heat exchange device 100 according to the embodiment of the present disclosure may minimize heat loss without using a separate insulator. The heat exchange device 100 according to an embodiment of the present disclosure may further include a cover 30 coupled to the top of the first heat exchanger 10 and the second heat exchanger 20 to suck the second gas from the outside or discharge the first gas, and a flow path changer configured to determine a flow path between the first heat exchanger 10 and the second heat exchanger 20. Elements of the cover 30 and the flow path changer 40 will be described below.

Hereinafter, each element of the heat exchange device 100 according to the embodiment of the present disclosure will be described in detail with reference to the drawings.

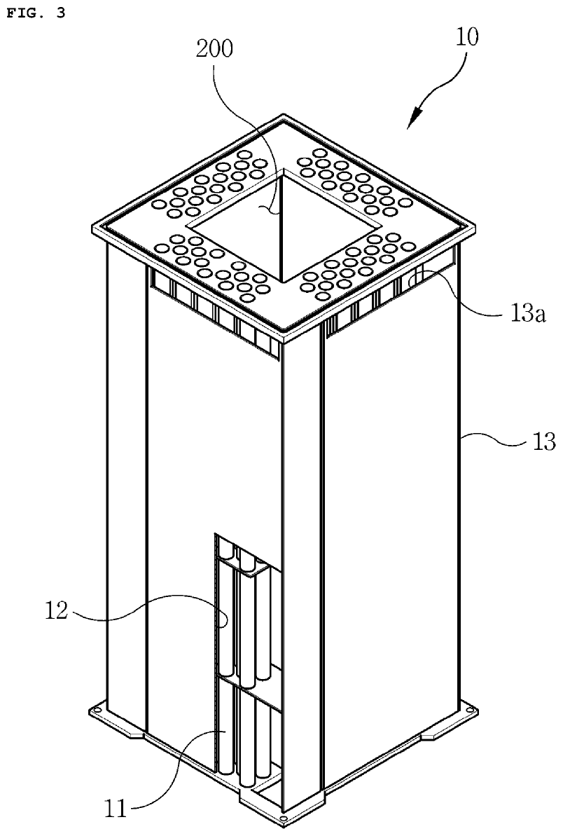

FIG. 3 is a perspective view showing a first heat exchanger according to an embodiment of the present disclosure.

Referring to FIGS. 1 to 3, the first heat exchanger 10 may be formed in a tubular shape having the reactor 200 formed at a central portion thereof. While the first heat exchanger 10 is shown to have a horizontal cross section of a rectangular tubular shape, embodiments are not limited thereto. The horizontal cross section may be formed in a variety of tubular shapes such as a circular tube and a hexagonal tube.

The first heat exchanger 10 surrounding the reactor 200 may be provided, in the lateral space thereof, with a first passage 11 communicating with the reactor 200 to allow the first gas discharged from the reactor 200 to pass therethrough. Here, the first passage 11 may be penetrated in a longitudinal direction perpendicular to the ground. As the first passage 11 is formed in a direction perpendicular to the ground, that is, in a direction in which gravity acts, dust contained in the first gas may be prevented from accumulating in the passage.

The first heat exchanger 10 may also be provided with a second passage 12 to receive the second gas introduced from the second heat exchanger 20 and allow the second gas to perform heat exchange with the first gas and then flow into the reactor 200. Here, the second passage 12 may be penetrated in the longitudinal direction perpendicular to the ground. The second passage and the first passage 11 may be disposed adjacent to each other in a sealed state. As the second passage 12 is formed in a direction perpendicular to the ground, that is, in a direction in which gravity acts, dust contained in the second gas may be prevented from accumulating in the passage.

At least one of the first passage 11 and the second passage 12 of the first heat exchanger 10 may be formed of a tube, and the other one may be formed in a shell shape to accommodate the tube. Preferably, the first passage 11 may be formed of a tube, and the second passage 12 may be formed in a shell shape. This is intended to allow the first gas passing through a third passage 21 of the second heat exchanger 20 to perform heat exchange with the second gas in the second passage 12, which will be described later. The first passage 11 and the second passage 12 may be formed in a shell-tube shape to allow heat exchange to be performed between the first gas and the second gas.

That is, a space may be formed inside each of the outer lateral surfaces of the first heat exchanger 10. This space may be the second passage 12, and a plurality of tubes vertically penetrating the second passage 12 may be the first passage 11.

Here, the first passage 11 may receive the first gas from above and discharge the introduced first gas downward. Here, the first gas discharged may move to the flow path changer 40, which will be described later.

The second passage 12 may receive the second gas through the space formed in the lower portion thereof, and discharge the second gas through a discharge path 13a formed in an upper portion of a partition wall 13 of each outer lateral surface positioned at the outermost portion of the first heat exchanger 10. Here, the second gas that has passed through the discharge passage 13a may move to the flow path changer 40, which will be described later, along the outer surfaces of the partition walls.

That is, the first passage 11 and the second passage 12 may have a counter-flow path structure in which the first gas and the second gas flow in opposite directions.

The first passage 11 and the second passage 12 in the first heat exchanger 10 according to the embodiment of the present disclosure communicate with the second heat exchanger 20 by the cover 30 and the flow path changer 40. However, embodiments are not limited thereto. The first passage 11 may be designed to be directly connected to the third passage 21, and the second passage 12 may be designed to be directly to a fourth passage 22.

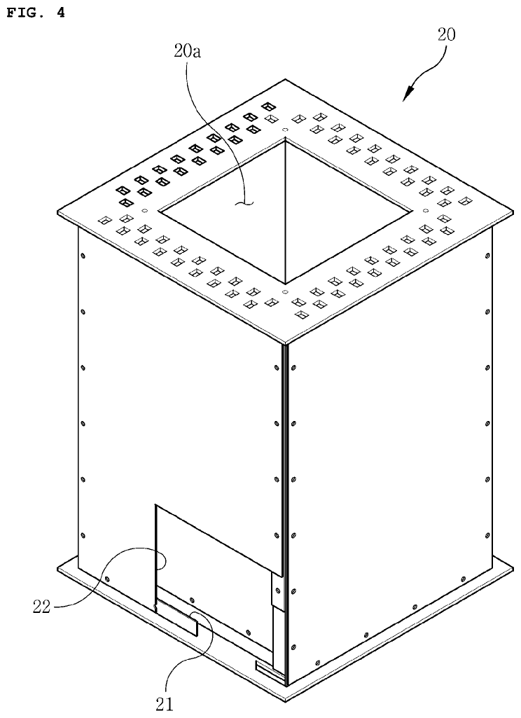

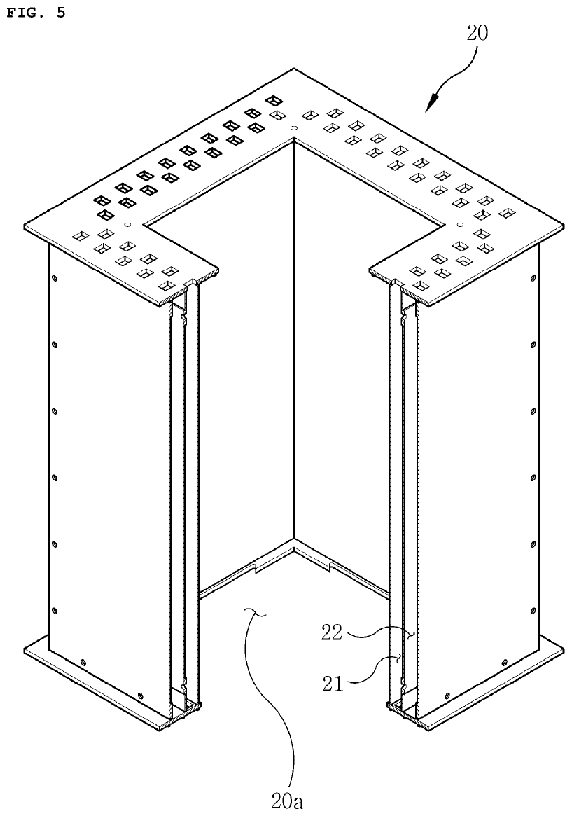

Hereinafter, the second heat exchanger 20 according to an embodiment of the present disclosure will be described in more detail with reference to the drawings. FIG. 4 is a perspective view showing a second heat exchanger according to an embodiment of the present disclosure, and FIG. 5 is a cross-sectional side view of the second heat exchanger according to the embodiment of the present disclosure.

Referring to FIGS. 1 to 5, the second heat exchanger 20 may be provided with a hollow 20a extending from the top surface of the central portion thereof to the bottom surface thereof to accommodate the first heat exchanger 10. Here, the hollow may be formed to correspond to the outer lateral portion of the first heat exchanger 10, and may be designed to contact the first heat exchanger 10 when coupled thereto. In addition, the second heat exchanger 20 may be provided with a third passage 21 through which the first gas introduced from the first heat exchanger 10 is received through the flow path changer 40 and discharged to the outside. Here, the third passage 21 may be formed in the lateral space of the second heat exchanger 20 in a direction perpendicular to the ground, that is, in a direction in which gravity acts, thereby preventing dust contained in the first gas from accumulating therein.

The second heat exchanger 20 may also be provided with a fourth passage 22 through which the second gas is received from the outside and introduced into the second passage 12 of the first heat exchanger 10 through the flow path changer 40. Here, the fourth passage 22 may be formed in the lateral space of the second heat exchanger 20, that is, the outer lateral portion of the third passage 21 so as to be separated from the third passage 21, and may be formed in a direction perpendicular to the ground, that is, in a direction in which gravity acts, thereby preventing dust contained in the second gas from accumulating therein.

That is, an empty space may be formed in each lateral side of the second heat exchanger 20, and the third passage 21 and the fourth passage 22 may be compartmentalized by the partition wall between the inner surface and the outer surface of the heat exchanger. In addition, the top and bottom of each of the third passage 21 and the fourth passage 22 may be provided with a plurality of holes to communicate with the cover 30 and the flow path changer 40, but embodiments are not limited thereto. Although it is shown that a plurality of holes is formed, it may also be formed to be open.

The third passage 21 and the fourth passage 22 are compartmentalized by the partition wall disposed at the center. However, embodiments are not limited thereto. Each of the third passage 21 and the fourth passage 22 may have a plurality of partition walls for higher heat exchange efficiency, and may be configured to be partitioned from each other. That is, the third passage 21 and the fourth passage 22 may include a plurality of passages, and may be disposed in a cross form to communicate with each other to form a cross flow.

In addition, the third passage 21 and the fourth passage 22 may have a plurality of fins formed on the inner surface thereof. Accordingly, the plurality of fins of the third passage 21 and the fourth passage 22 may increase the internal surface area, thereby maximizing heat exchange efficiency.

Hereinafter, the cover 30 and the flow path changer 40 of the present disclosure will be described in more detail with reference to the drawings.

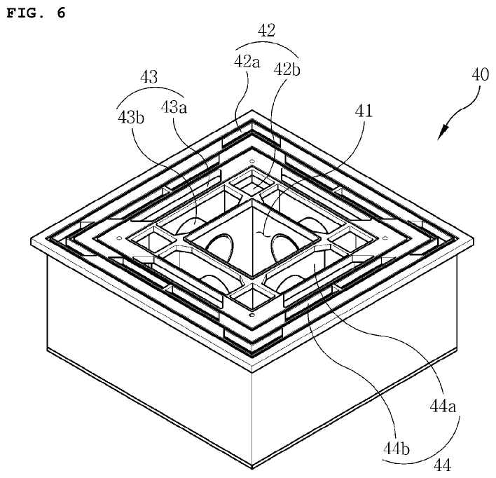

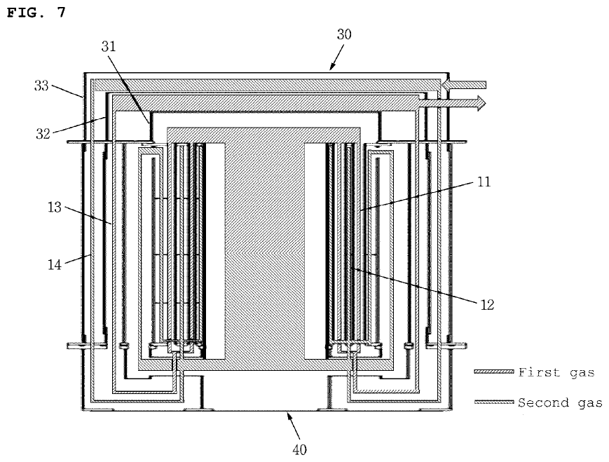

FIG. 6 is a perspective view showing a flow path changer according to an embodiment of the present disclosure, and FIG. 7 is a view illustrating the flow of first and second gases in the heat exchange device according to the embodiment of the present disclosure.

Referring to FIGS. 1 to 7, the cover 30 according to an embodiment of the present disclosure may be installed on the top of the first heat exchanger 10 and the second heat exchanger 20 coupled to each other. The cover 30 may serve to change the flow paths of the first gas and the second gas moving in the first heat exchanger 10 and the second heat exchanger 20, and may protect the first heat exchanger 10 and the second heat exchanger 10.

The cover 30 may include a first cover 31 communicating with the first passage 11 to transfer the first gas from the reactor 200 to the first passage, a second cover 32 disposed spaced apart from the first cover 31 and provided with a first duct 30a communicating with the third passage 21 to discharge the first gas discharged from the third passage 21 to the outside, and a third cover 33 disposed spaced apart from the second cover 32 and provided with a second duct 30b communicating with the fourth passage 22 to introduce the second gas flowing from the outside into the fourth passage 22.

Here, the first cover 31 may be provided therein with a space through which the first gas may flow, and seal the top of the first heat exchanger 10 at the boundary between the first passage 11 and the third passage 21 with the top thereof sealed. Accordingly, the first gas generated in the reactor 200 may flow into the first passage 11 along the space sealed by the first cover 31.

The second cover 32 may be spaced apart from the first cover to form therein a space through which the first gas discharged through the third passage 21 may flow, and may seal the top of the second heat exchanger 20 at the boundary between the third passage 21 and the fourth passage 22 with the top thereof sealed. Accordingly, the first gas discharged from the third passage 21 may move along the space between the first cover 31 and the second cover 32 to be discharged to the outside through the first duct 30a. Here, the first duct 30a positioned outside may communicate with a space between the second cover 32 and the first cover 31 through the lateral surface of the second cover 32.

The third cover 33 may be spaced apart from the second cover to form therein a space through which the second gas discharged through the fourth passage 22 may flow, and may seal the top of the second heat exchanger 20 at the boundary of the outer lateral side of the fourth passage 22 with the top thereof sealed. Accordingly, the second gas introduced through the second duct 20b may move along the space between the third cover 33 and the second cover 32 to flow into the fourth passage 22. Here, the second duct 30a positioned outside may communicate with the space between the third cover 33 and the second cover 32 through the lateral surface of the third cover 33.

Although not shown, the first duct 30a and the second duct 30b may be further provided therein with a filter capable of filtering dust contained in the first gas or the second gas, respectively.

The flow path changer 40 may be coupled to the bottom of the first heat exchanger 10 and the second heat exchanger 20 coupled to each other. That is, the flow path changer 40 may be disposed to face the cover 30. Here, the flow path changer 40 may form a communication flow path between the first passage 11 and the third passage 21 and between the second passage 12 and the fourth passage 22.

The flow path changer 40 may include a source accommodation portion 41, a first flow path changer 42, a second flow path changer 43, and a third flow path changer 44.

The source accommodating portion 41 is a groove formed in the center and may communicate with the reactor 200. Thus, it may be provided with a source for reaction in the reactor 200. For example, a burner for heating the second gas introduced from the outside may be installed in the source accommodating portion 41.

The first flow path changer 42 may cause the second gas introduced through the fourth passage 22 to flow into the second passage 12. That is, the second gas introduced through the fourth passage 22 may flow through a first flow path 42a to be introduced into the second passage 12 through a second flow path 42b internally communicating with the first flow path 42a.

The second flow path changer 43 may cause the second gas introduced through the second passage 12 by the first flow path changer 42 to flow into the source accommodation portion 41. That is, the second gas introduced from the second passage 12 may flow through the third flow path 43a and be introduced into the source accommodation portion 41 through the fourth flow path 43b internally communicating with the third flow path 43a.

The third flow path changer 44 may discharge the first gas discharged from the first passage 11 via the reactor 200 to the third passage 21. That is, the first gas discharged from the first passage 11 may pass through a fifth passage 44a and be discharged into the third passage 21 through a sixth passage 44b internally communicating with the fifth passage 44a.

The cover 30 and the flow path changer 40 may be detachably coupled to the first and second heat exchange devices 10 and 20, respectively.

Accordingly, as the cover 30 and the flow path changer 40 that form flow paths of the first heat exchanger 10 and the second heat exchanger 20 are detachably coupled to the top and bottom of the first heat exchanger 10 and the second heat exchanger 20, respectively, maintenance of the heat exchange device according to the embodiment of the present disclosure may be facilitated.

Hereinafter, the flows of the first gas and the second gas in the heat exchange device 100 according to the embodiment of the present disclosure are conceptually described below. First, the first gas generated in the reactor 200 flows into the first passage 11 through the first cover 31, and is cooled for the first time by performing heat exchange with the second gas moving from the first passage 11 to the second passage 12. Then, the first gas discharged from the first passage 11 flows into the third passage 21 through the flow path changer 40 and is cooled for the second time by performing heat exchange with the second gas moving from the third passage 21 to the fourth passage 22. Then, the first gas discharged from the third passage 21 is discharged to the outside by the second cover 32.

The second gas introduced from the outside enters the fourth passage 22 through the third cover 33, and performs heat exchange with the first gas moving from the fourth passage 22 to the third passage 21. The second gas introduced from the third passage 21 flows into the second passage 12 through the flow path changer 40 and performs heat exchange with the first passage 11 through the second passage 12. Then, the second gas introduced from the second passage 12 flows into the reactor 200 through the flow path changer 40. The flow path changer 40 and the cover 30 may be arranged to face in opposite directions. That is, the flow path changer 40 may be disposed at the top of the first heat exchanger 10 and the second heat exchanger 20, and the cover 30 may be disposed at the bottom of the first heat exchanger 10 and the second heat exchanger 20 to face the flow path changer 40. Here, even when the flow directions of the first gas and the second gas are reversed, the structures of the first heat exchanger 10 and the second heat exchanger 20 are the same, and a counter-flow structure in which the first gas and the second gas flow in opposite directions may be formed. The embodiments disclosed in the drawings are merely presented as specific examples to provide understanding of the present disclosure, and are not intended to limit the scope of the present disclosure. It is apparent to those skilled in the art to which the present disclosure pertains that other modifications based on the technical spirit of the present disclosure can be implemented in addition to the embodiments disclosed herein.

1. A heat exchange device comprising:
first heat exchanger having a reactor formed in a center thereof, the first heat exchanger comprising:
a first passage disposed to surround the reactor and allowing a first gas generated in the reactor to be discharged thereinto; and
a second passage disposed adjacent to the first passage to receive a second gas introduced from an outside; and
a second heat exchanger arranged to surround the first heat exchanger, the second heat exchanger comprising:
a third passage connected to the first passage to receive the first gas from the first passage and discharge the first gas to the outside; and
a fourth passage disposed adjacent to the third passage and configured to introduce the second gas introduced from the outside into the second passage.

2. The heat exchange device of claim 1, wherein the second heat exchanger is arranged to surround a lateral surface of the first heat exchanger.

3. The heat exchange device of claim 1, wherein the first to fourth passages are formed perpendicular to a ground.

4. The heat exchange device of claim 3, wherein at least one of the first passage and the second passage is formed of a tube, and the other is formed in a shell shape to accommodate the tube.

5. The heat exchange device of claim 4, further comprising:
a cover arranged on a top of the first heat exchanger and the second heat exchanger to discharge the first gas discharged from the third passage to the outside and to receive the second gas from the outside and introduce the second gas into the fourth passage; and
a flow path changer disposed at a bottom of the first heat exchanger and the second heat exchanger to face the cover to form communication flow paths between the first passage and the third passage and between the second passage and the fourth passage.

6. The heat exchange device of claim 5, wherein the cover comprises:
a first cover communicating with the first passage to transfer the first gas from the reactor to the first passage;
a second cover disposed spaced apart from the first cover and having a first duct communicating with the third passage to discharge the first gas discharged from the third passage to the outside; and
a third cover disposed spaced apart from the second cover and having a second duct communicating with the fourth passage to introduce the second gas introduced from the outside into the fourth passage.

7. The heat exchange device of claim 6, wherein the flow path changer comprises:
a source accommodation portion forming a space in a center thereof to communicate with the reactor, the source accommodation being provided with a source for reaction in the reactor;
a first flow path changer configured to introduce, into the second passage, the second gas introduced through the fourth passage;
a second flow path changer configured to introduce, into the source accommodation portion, the second gas introduced through the second passage by the first flow path changer; and
a third flow path changer configured to discharge the first gas discharged from the first passage through the reactor into the third passage.

8. The heat exchange device of claim 5, wherein the cover and the flow path changer are detachably coupled to the first and second heat exchangers.

9. The heat exchange device of claim 1, wherein the first gas and the second gas form counter-flows by moving in opposite directions.
